(19) United States
(12) Patent Application Publication
(10) Pub. No.: US 2013/0207930 A1
(43) Pub. Date: Aug. 15, 2013

(54) TOUCH DISPLAY PANEL

(71) Applicants: Yi-Chun Lin, Nantou County (TW); Chia-Chi Chen, Taichung City (TW); Ming-Kung Wu, Taichung City (TW)

(72) Inventors: Yi-Chun Lin, Nantou County (TW); Chia-Chi Chen, Taichung City (TW); Ming-Kung Wu, Taichung City (TW)

(73) Assignees: WINTEK CORPORATION, Taichung City (TW); Wintek (China) Technology Ltd., Guangdong Province (CN)

(21) Appl. No.: 13/761,154

(22) Filed: Feb. 7, 2013

(30) Foreign Application Priority Data
Feb. 10, 2012 (TW) 101104416

(51) Int. Cl. G06F 3/044

(52) U.S. Cl. CPC G06F 3/044
USPC 345/174

(57) ABSTRACT

A touch display panel including a display panel and a touch panel is provided. The display panel includes a plurality of pixels. The touch panel is located on the display panel. The touch panel includes a plurality of first touch sensing series, a plurality of second touch sensing series, and an insulating layer. An overlapped region is formed at an intersection of each of the first touch sensing series and each of the second touch sensing series. An area of the insulating layer orthogonally projected on the display panel covers each overlapped region. The surface of the insulating layer has bumps corresponding to each overlapped region of each first touch sensing series and each second touch sensing series. By this way, a problem that users easily see bright spots located at the intersection of each first touch sensing series and each second touch sensing series can be avoided.

### CROSS-REFERENCE TO RELATED APPLICATION

This application claims the priority benefit of Taiwan application serial no. 101104416, filed on Feb. 10, 2012. The entirety of the above-mentioned patent application is hereby incorporated by reference herein and made a part of this specification.

### BACKGROUND OF THE INVENTION

1. Field of the Invention

The invention is directed to a touch display panel, and more particularly, to a touch display panel which enhances the overall visual effect.

2. Description of Related Art

In the current information society, many information technology (IT) products, instead of using conventional keyboards or mice, have been utilizing touch sensing panels as the input devices. Among various touch sensing panels, a touch display panel capable of performing both a touch sensing function and a display function is one of the most popular products at present.

In the conventional touch sensing panel, a touch sensing circuit thereof including a plurality of X-sensing series and a plurality of Y-sensing series is provided. The X-sensing series and the Y-sensing series are intersected with each other. In general, two touch sensing pads adjacent to an intersection of the X-sensing series and the Y-sensing series are electrically connected via a metal conduction line. However, pixels and other internal structures of the conventional touch display panel may be easily observed by users. Specially, a bright spot is easily seen by the users at the intersection of the X-sensing series and the Y-sensing series, which deteriorates the overall display quality of the touch display panel. Thus, the visual quality of the conventional touch display panel is one of the most important issues to be resolved.

In China patent publication no. CN101776969, a touch display panel is provided. As illustrated in FIG. 1, a touch display panel 100 includes first touch sensing series 110 and second touch sensing series 120. The first touch sensing series 110 include first touch sensing pads 112 and first connection lines 114. The second touch sensing series 120 include second touch sensing pads 122 and second connection lines 124. As illustrated in FIG. 1, bump patterns B are randomly and evenly distributed on the first and second touch sensing series 110 and 120. Through blurring an image displayed on the touch display panel, it is no longer for a user to easily observe the outline of the sensing pads. However, the layout illustrated in FIG. 1 cannot resolve the problem that the user easily sees the bright spots at the intersection of the X-sensing series and the Y-sensing series. Meanwhile, the layout illustrated in FIG. 1 easily results in a haze effect on the touch display panel, which causes reduction of the overall transmittance. In addition, as illustrated in FIG. 1, if a single bump pattern B is located at the intersection of the X-sensing series and the Y-sensing series, a magnifying effect (similar to that achieved by a convex lens) occurs, and thereby users are more likely to see a bright spot.

### SUMMARY OF THE INVENTION

In the invention, a touch display panel is provided to resolve the problem that a user easily sees bright spots located at an intersection of two touch sensing series, and therefore a better visual effect is provided.

The invention is directed to a touch display panel including a display panel and a touch panel. The display panel includes a plurality of pixels. The touch panel is located on the display panel. The touch panel includes a plurality of first touch sensing series, a plurality of second touch sensing series, and an insulating layer. An overlapped region is formed at an intersection of each of the first touch sensing series and each of the second touch sensing series. An area of the insulating layer orthogonally projected on the display panel covers an area of each overlapped region. The surface of the insulating layer has a plurality of bumps within each overlapped region of each of the first touch sensing series and each of the second touch sensing series.

According to an embodiment of the invention, the insulating layer is located between each of the first touch sensing series and each of the second touch sensing series. Each of the first touch sensing series includes a plurality of first touch sensing pads and a plurality of first conduction lines. Each of the first conduction lines is located between two of the first touch sensing pads that are adjacent thereto. Each of the second touch sensing series includes a plurality of second touch sensing pads and a plurality of second conduction lines. Each of the second conduction lines is located between two of the second touch sensing pads that are adjacent thereto.

According to an embodiment of the invention, the insulating layer includes a plurality of dielectric island patterns. Each of the dielectric island patterns is exclusively located between one of the first conduction lines and one of the second conduction lines.

According to an embodiment of the invention, the insulating layer includes a plurality of openings. Each of the openings is located on two ends of each of the first conduction lines. Each of the first touch sensing pads is serially connected with one of the first conduction lines via one of the openings.

According to an embodiment of the invention, the touch display panel further includes a protecting layer, which covers the first touch sensing series and the second touch sensing series. The insulating layer may be located over the protecting layer. The touch display panel further includes an inter-layer dielectric layer, which is located between each of the first touch sensing series and each of the touch sensing series. An upper surface of the inter-layer dielectric layer away from the pixels is a convex surface.

According to an embodiment of the invention, the area of the insulating layer projected on the display panel is larger than an area of the inter-layer dielectric layer projected on the display panel.

According to an embodiment of the invention, each of the first touch sensing series includes a plurality of first touch sensing pads and a plurality of first conduction lines. Each of the first conduction lines is located between two of the first touch sensing pads that are adjacent thereto. Each of the second touch sensing series includes a plurality of second touch sensing pads and a plurality of second conduction lines. Each of the second conduction lines is located between two of the second touch sensing pads that are adjacent thereto.

According to an embodiment of the invention, the inter-layer dielectric layer includes a plurality of dielectric island patterns, each of which is exclusively located between one of the first conduction lines and one of the second conduction lines.

According to an embodiment of the invention, the inter-layer dielectric layer includes a plurality of openings located on two ends of the first conduction lines. Each of the first touch sensing pads is serially connected with one of the first conduction lines via one of the openings.

According to an embodiment of the invention, a height of each of the bumps is greater than 0 micrometer and smaller than 20 micrometers.

According to an embodiment of the invention, a distance between each of the bumps is greater than 0 micrometer and smaller than 15 micrometers.

According to an embodiment of the invention, a dimension of each of the bumps is greater than 0 micrometer and smaller than 30 micrometers.

As a result, in the touch display panel of the invention, the insulating layer having a plurality of bumps is disposed on the overlapped region where each of the first touch sensing series and the second touch sensing series are intersected. The area of the insulating layer projected on the display panel covers the overlapped region of the two touch sensing series. The surface of the insulating layer has a plurality of bumps on the single overlapped region. Thereby, an image light on the display panel may be appropriately scattered when it passes through the insulating layer, so as to solve the problem that the internal structures may be easily seen due to the magnified pixels and preclude the user from easily observing the bright spots at the intersection of two touch sensing series. Hence, the touch display panel provides a favorable visual effect.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a conventional touch display panel.

FIG. 2 is a top schematic view of a touch display panel according to an embodiment of the invention.

FIG. 3 is a schematic cross-sectional view of an intersection of two touch sensing series of a touch display panel according to a first embodiment of the invention.

FIGS. 4A and 4B are schematic views illustrating distribution of bumps on an insulating layer according to an embodiment of the invention.

FIG. 5 is a schematic cross-sectional view illustrating an intersection of two touch sensing series of a touch display panel according to a second embodiment of the invention.

FIG. 6 is a schematic cross-sectional view illustrating an intersection of two touch sensing series of a touch display panel according to a third embodiment of the invention.

FIG. 7 is a schematic cross-sectional view illustrating an intersection of two touch sensing series of a touch display panel according to a fourth embodiment of the invention.

FIG. 8 is a schematic cross-sectional view illustrating an intersection of two touch sensing series of a touch display panel according to a fifth embodiment of the invention.

FIG. 9 is a schematic cross-sectional view illustrating an intersection of two touch sensing series of a touch display panel according to a sixth embodiment of the invention.

FIG. 10A is a partially enlarged view illustrating a conventional touch display panel which is not equipped with an insulating layer having bumps, and FIG. 10B is a top view showing the touch display panel that is depicted according to the arrangement shown in FIG. 10A.

FIG. 11A a partially enlarged view illustrating a conventional touch display panel which is equipped with an insulating layer having a plurality of bumps, and FIG. 11B is a top view showing the touch display panel that is depicted according to the arrangement shown in FIG. 11A.

### DESCRIPTION OF EMBODIMENTS

Generally, a color filter in a display panel includes pixels having a periodic structure, and an insulating layer is disposed between two touch sensing series that are intersected with each other in a touch panel. However, since the shape of the insulating layer in a product has a focus effect similar to that achieved by a convex lens, the pixels located under the insulating layer are easily magnified, which leads a user to observe undesired bright spots. As a result, the touch display panel may have unsatisfactory visual effects. Thus, the insulating layer of the invention is appropriately designed in consideration of the above.

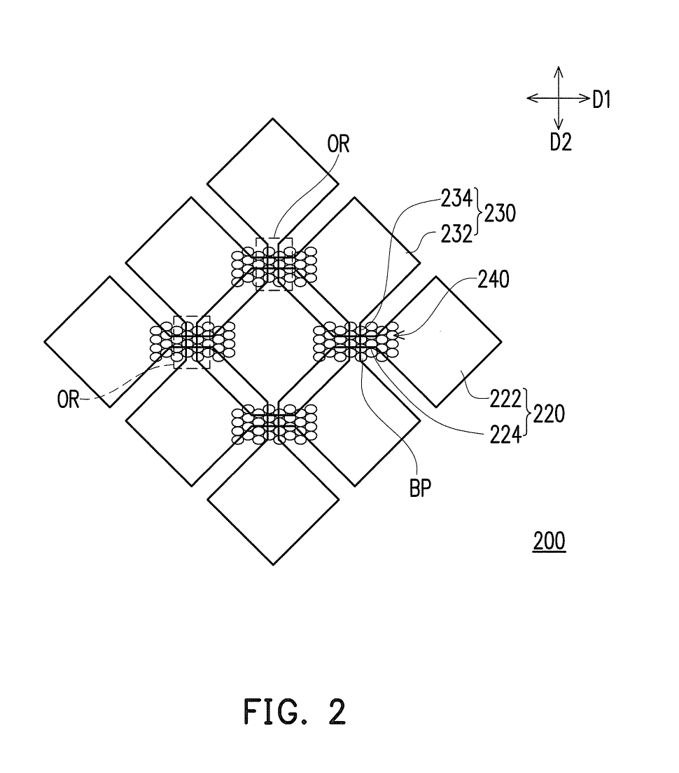

In brief, FIG. 2 is a top schematic view of a touch display panel according to an embodiment of the invention. To describe clearly, only touch sensing pads, conduction lines, and insulating layers are shown in FIG. 2, and other components are omitted. Specifically, each of the first touch sensing series 220, for example, extends along a first direction D1 and includes a plurality of first touch sensing pads 222 serially connected with each other and a plurality of first conduction lines 224. Each of the first conduction lines 224 is located between two of the first touch sensing pads 222 that are adjacent thereto. Each of the second touch sensing series 230, for example, extends along a second direction D2 and includes a plurality of second touch sensing pads 232 serially connected with each other and a plurality of second conduction lines 234. Each of the second conduction lines 234 is located between two of the second touch sensing pads 232 that are adjacent thereto.

As illustrated in FIG. 2, an insulating layer 240 having a surface with a plurality of bumps BP is disposed between the intersected first and second touch sensing series 220 and 230 of the touch display panel 200 according to the invention. By this way, a light emitted from the display panel located at the bottom of the touch display panel is appropriately scattered when the light passes through the insulating layer 240 having the bumps BP, so that the light of an image is appropriately scattered before it reaches a user, and thus the issue of bright spots easily occurring at the intersection of the two touch sensing series is resolved.

In addition, the insulating layer 240 having the bumps BP in the invention can be compatible with the existing manufacturing processes. In detail, according to an embodiment, the insulating layer 240 having the bumps BP replaces an inter-layer dielectric layer located between two touch sensing series so that the two intersected touch sensing series are electrically insulated from each other. In another embodiment of the invention, the insulating layer 240 having the bumps BP is disposed over a protecting layer which covers the two touch sensing series. The insulating layer 240 can be also applied to different designs, such as a bridge island design or a bridge via design. A few embodiments thereof will be illustrated below, but the invention is not limited thereto.

### First Embodiment

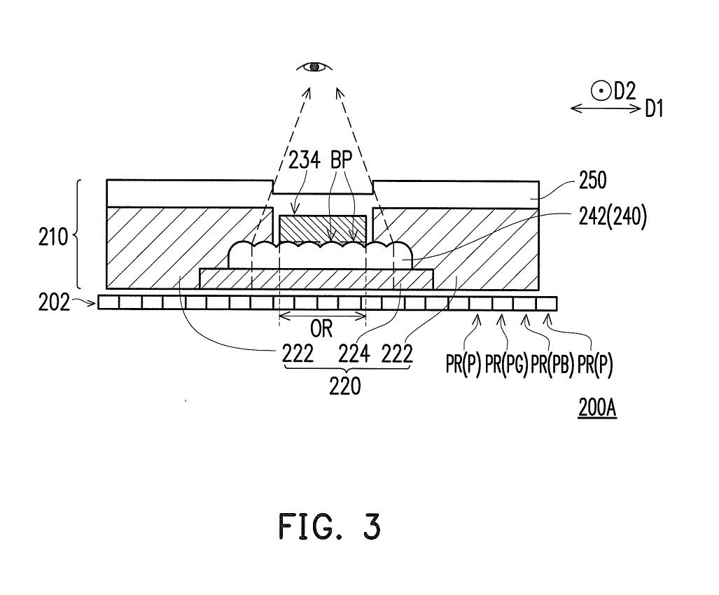

FIG. 3 is a cross-sectional schematic view of an intersection of two touch sensing series of a touch display panel according to a first embodiment of the invention. As illustrated in FIG. 3, a touch display panel 200A includes a display panel 202 and a touch panel 210. The display panel 202 is a liquid crystal display (LCD) panel, for example. In other embodiments, the display panel 202 may also be an organic light-emitting display panel, an electrowetting display panel, or an electrophoretic display panel. The display panel 202 has a plurality of pixels P arranged thereon in arrays. The pixels P may consist of a plurality of red pixels PR, a plurality of green pixels PG, and a plurality of blue pixels PB.

The touch panel 210 is located on the display panel 202. The touch panel 210 includes a plurality of first touch sensing series 220, a plurality of second touch sensing series 230, an insulating layer 240, and a protecting layer 250. An overlapped region OR is formed at an intersection of each of the first touch sensing series 220 and each of the second touch sensing series 230. As illustrated in FIG. 2 and FIG. 3, an area of the insulating layer 240 orthogonally projected on the display panel 202 covers an area of each overlapped region OR orthogonally projected on the display panel 202. As to the arrangement of stacked film layers, the insulating layer 240 of the present embodiment, for example, is located between each of the first touch sensing series 220 and each of the second touch sensing series 230 and serves as a dielectric material that electrically insulate the two touch sensing series 220 and 230. Here, the insulating layer 240 is made of an organic material, for example. The protecting layer 250 of the present embodiment, for example, covers the first touch sensing series 220, the second touch sensing series 230, and the insulating layer 240.

In more detail, according to the present embodiment, the insulating layer 240 includes a plurality of dielectric island patterns 242. Each of the dielectric island patterns 242 is exclusively located between one of the first conduction lines 224 and one of the second conduction lines 234 intersected therewith, so that the intersected first and second touch sensing series 220 and 230 are electrically insulated from each other, and the first touch sensing pads 222 are exposed. In addition, according to the present embodiment, each of the first conduction lines 224 and each of the second conduction lines 234 are respectively located on and under one of the dielectric island patterns 242. A material of the first conduction lines 224 and the second conduction lines 234 is a transparent conductive material or metal. Certainly, the positions of the first conduction lines 234 and the second conduction lines 234 may be exchanged, but the invention is not limited thereto.

Specially, within the overlapped region OR of each of the first touch sensing series 220 and each of the touch sensing series 230, a surface of each of the dielectric island patterns 242 in the insulating layer 240 of the present embodiment has a plurality of bumps BP in each overlapped region OR, so that light passing through the insulating layer 240 is effectively scattered. In order to resolve the issue of bright spots occurring at the intersection of the two touch sensing series, the insulating layer 240 in the invention is disposed within the overlapped region at the intersection of the two touch sensing series, and an area of the insulating layer 240 orthogonally projected on the display panel 202 covers the overlapped region OR. The plurality of bumps BP are intentionally disposed on the surface of one of the dielectric island patterns 242 in the insulating layer 240 within the range of one of the overlapped region OR such that the light paths changed by the bumps BP interfere with one another. Thereby, the light scattering effect is appropriately produced, and the user may be prevented from observing bright spots at the intersection of the two touch sensing series. Meanwhile, since the insulating layer 240 of the present embodiment is merely distributed at the intersection of the two touch sensing series without extending to the top of each of the first touch sensing pads 222 and each of the second touch sensing pads 232, a haze effect on the displayed image is rather subtle. Accordingly, the overall visual effect is effectively enhanced.

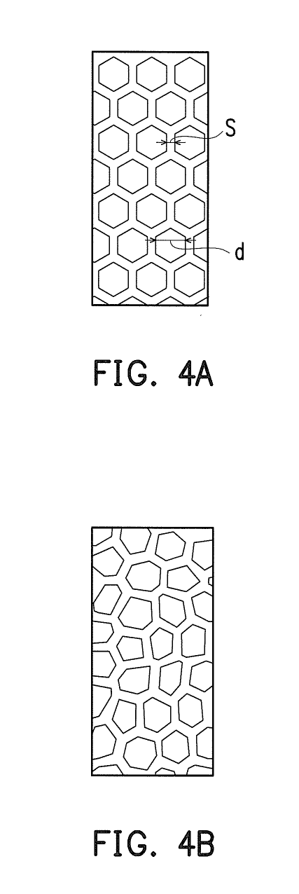

It should be mentioned that each of the bumps BP may be in a regular form. As illustrated in FIG. 4A, each of the bumps BP, for example, is a regular hexagon, which a dimension of the bump BP is d, and a distance between the bumps BP is S. In consideration of the light scattering effect of the bumps BP and the electrical performance of the original touch sensing components, a height of each of the bumps BP is, optimally, larger than 0 micrometer and smaller than 20 micrometers, a distance S between each of the bumps BP is larger than 0 micrometer and smaller than 15 micrometers, and a dimension d of each of the bumps BP is larger than 0 micrometer and smaller than 30 micrometers. When the height of each of the bumps BP is larger than 20 micrometers, the connection between the first touch sensing series 220 and the second touch sensing series 230 may be affected, which results in disconnection or subsequent deformation of patterns of film layers and further influences the electrical performance. Therefore, it is optimal for the aforementioned height of bumps and the distance between bumps to comply with said requirements. It is certain that each of the bumps BP may also have an irregular shape, as illustrated in FIG. 4B, while the invention is not limited thereto.

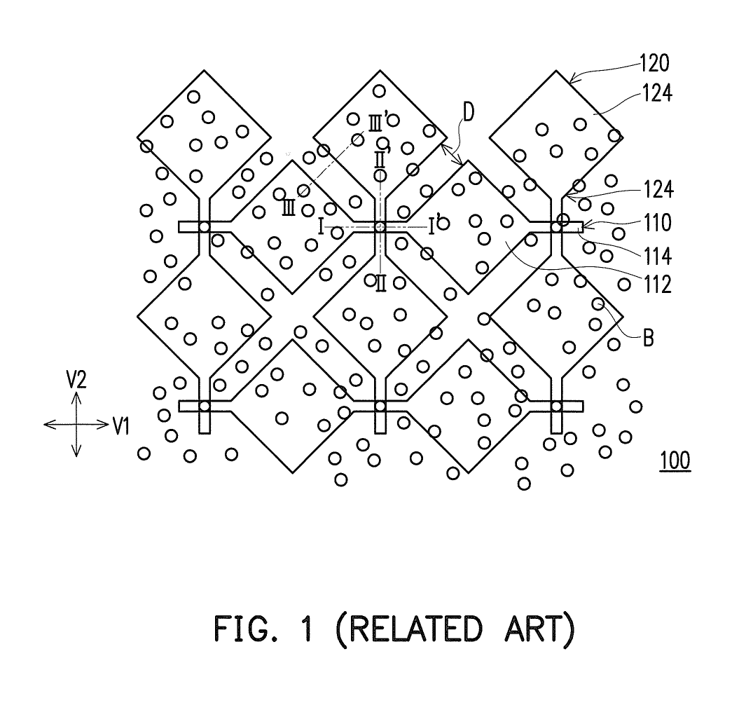

It should be noted that in comparison with the related art as illustrated in FIG. 1, the invention prohibits the bright spots problem by way of arranging the insulating layer 240 with the bumps BP between the first and second touch sensing series 220 and 230. On the other hand, according to the related art, bump patterns are randomly distributed on the touch sensing pads 112 and 122, so as to blur the entire outline of the touch sensing pads. Thus, according to the related art as illustrated in FIG. 1, even though the bump pattern B is unintentionally placed between two touch sensing series, the quantity of the placed bump pattern is one. However, as illustrated in the related art in FIG. 1, if a single bump is formed between two touch sensing series, no light scattering effect is achieved, and a spotlight effect similar to that achieved by a convex lens may even occur, which further accentuates the problem of bright spots located at the intersection of the two touch sensing series. Thus, the related art shown in FIG. 1 cannot effectively resolve the problem of visible bright spots to be solved in the invention.

### Second Embodiment

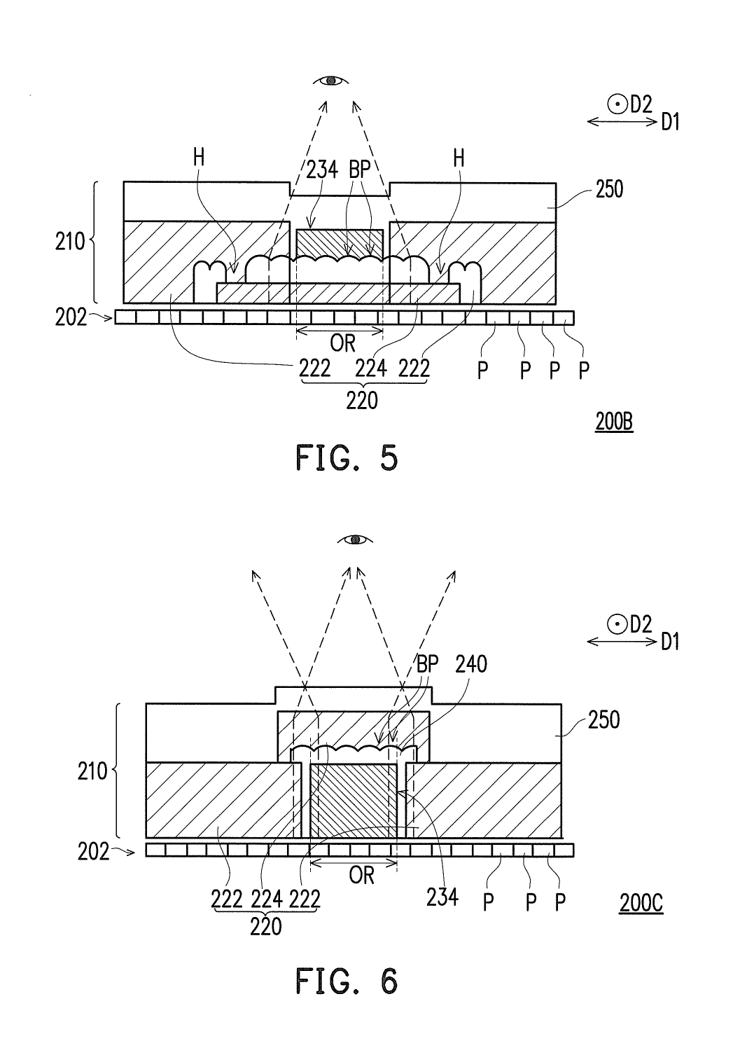

FIG. 5 is a cross-sectional schematic view illustrating an intersection of two touch sensing series of a touch display panel according to a second embodiment of the invention. As shown in FIG. 5, a touch display panel 200B described in the second embodiment is similar to the touch display panel 200A described in the first embodiment. Thus, the same components are labeled by the same reference numbers. However, in the present embodiment, the insulating layer 240 includes a plurality of openings H, and each of the openings H is located at two ends of each of the first conduction lines 224. Each of the first touch sensing pads 222 is serially connected with one of the first conduction lines 224 via one of the openings H. In other words, the touch display panel 200B of the present embodiment has a bridge via design.

Certainly, in the touch display panel 200B of the present embodiment, a plurality of bumps BP may also be disposed on the surface of the insulating layer 240 between the first conduction lines 224 and the second conduction lines 234. Thereby, an image light on the display panel 202 may be appropriately scattered when the light passing through the insulating layer 240 with the bumps BP. The problem that easily seen bright spots at the intersection of the two touch sensing series can be resolved, so that a favorable visual effect is provided.

### The Third Embodiment

FIG. 6 is a cross-sectional schematic view illustrating an intersection of two touch sensing series of a touch display panel according to a third embodiment of the invention. As illustrated in FIG. 6, a touch display panel 200C described in the third embodiment is similar to the touch display panel 200A described in the first embodiment. Thus, the same components are labeled by the same reference numbers. However, positions of stacked film layers discussed herein are different from those provided in the previous embodiments.

In detail, according to the first and the second embodiments, each of the conduction lines 224 is located under the protecting layer 250. However, in the present embodiment, each of the first conduction lines 224 is across the insulating layer 240 and serially connected with two adjacent first touch sensing pads 224. In other words, the touch display panel 200C of the present embodiment has a bridge island design.

Certainly, in the touch display panel 200C of the present embodiment, a plurality of bumps BP may also be disposed on the surface of the insulating layer 240 between the first conduction lines 224 and the second conduction lines 234. Thereby, an image light on the display panel 202 may be appropriately scattered when the light passing through the insulating layer 240 with the bumps BP. Thus, the problem that easily seen bright spots at the intersection between the two touch sensing series can be resolved, so as to provide a favorable visual effect.

### Fourth Embodiment

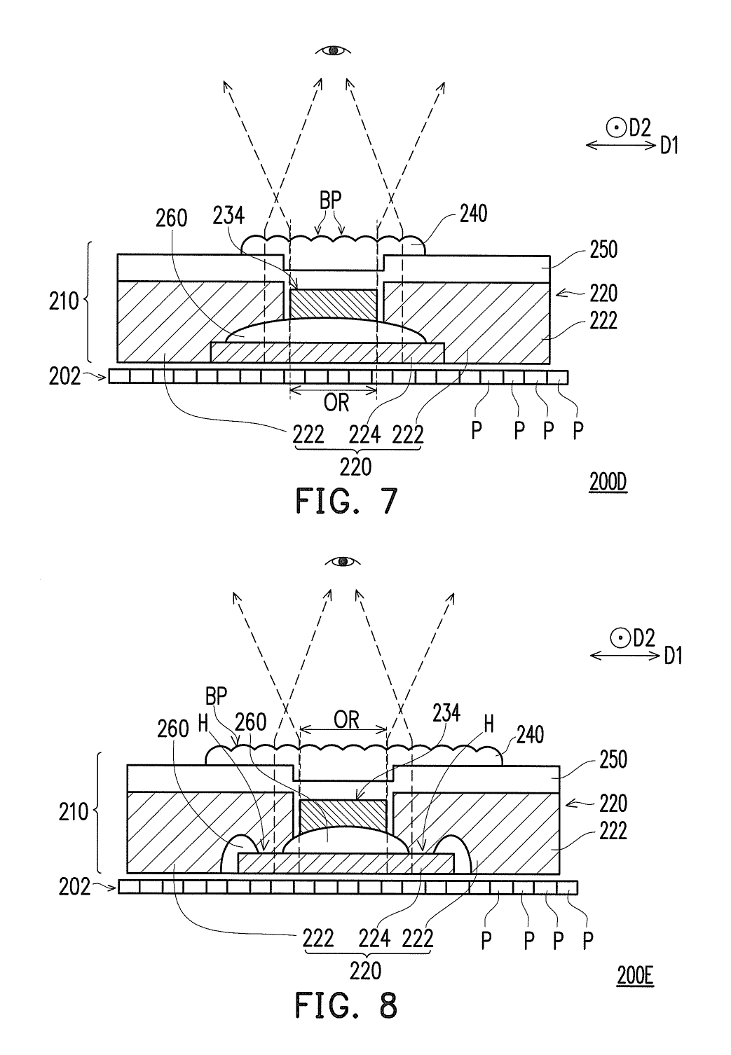

FIG. 7 is a cross-sectional schematic view illustrating an intersection of two touch sensing series of a touch display panel according to a fourth embodiment of the invention. As illustrated in FIG. 7, the insulating layer 240 described in each of the afore-mentioned embodiments is located between the protecting layer 250 and the first conduction lines 224; however, in a touch display panel 200D of the present embodiment, the insulating layer 240 is located over the protecting layer 250. In the present embodiment, a film layer located between each of the first touch sensing series 220 and each of the second touch sensing series 230, by which the two touch sensing series 220 and 230 are electrically insulated, is called an inter-layer dielectric layer 260. In other words, the insulating layer 240 of the present embodiment used for scattering the light is different from the inter-layer dielectric layer 260 disposed between the two touch sensing series 220 and 230, and different from the protecting layer 250 entirely covers the two touch sensing series 220 and 230.

As illustrated in FIG. 7, an upper surface of the inter-layer dielectric layer 260 away from the pixels P is a convex surface. In other words, according to the present embodiment, the insulating layer 240 having the bumps BP additionally covers a set of touch sensing components including the first touch sensing series 220, the second touch sensing series 230, and the inter-layer dielectric layer 260. Besides, the insulating layer 240 having the bumps BP is projected on the display panel 202, and the projection of the insulating layer 240 on the display panel also covers the overlapped region OR of each of the first touch sensing series 220 and each of the second touch sensing series 230 and the inter-layer dielectric layer 260 having the convex surface. Therefore, even though the inter-layer dielectric layer 260 having the convex surface may magnify the bright spots at the intersection of the two touch sensing series due to the focus effect similar to that achieved by the convex lens, as illustrated in the related art of FIG. 1, when the light passes through the insulating layer 240 having the bumps BP according to the present embodiment, the paths of the light are again changed by the bumps BP, so as to appropriately produce the light scattering effect and prevent users from observing bright spots at the intersection of the two touch sensing series.

### Fifth Embodiment

FIG. 8 is a cross-sectional schematic view illustrating an intersection of two touch sensing series of a touch display panel according to a fifth embodiment of the invention. As illustrated in FIG. 8, a touch display panel 200E described in the fifth embodiment is similar to the touch display panel 200D described in the fourth embodiment. Thus, the same components are labeled by the same reference numbers. However, in the present embodiment, the inter-layer dielectric layer 260 includes a plurality of openings H. Each of the openings H is located on two ends of each of the first conduction lines 224, and each of the first touch sensing pads 222 is serially connected with one of the first conduction lines 224 via one of the openings H. In other words, the touch display panel 200E has a bridge via design.

Certainly, in the touch display panel 200E of the present embodiment, when the image light on the display panel 202 passes through the insulating layer 240 having the bumps BP, the light scattering effect may also be appropriately produced because of the insulating layer 240 that is equipped with the bumps BP and located over the protecting layer 250. Thereby, the problem of easily seen bright spots at the intersection of the two touch sensing series may be resolved, so as to provide a favorable visual effect.

### Sixth Embodiment

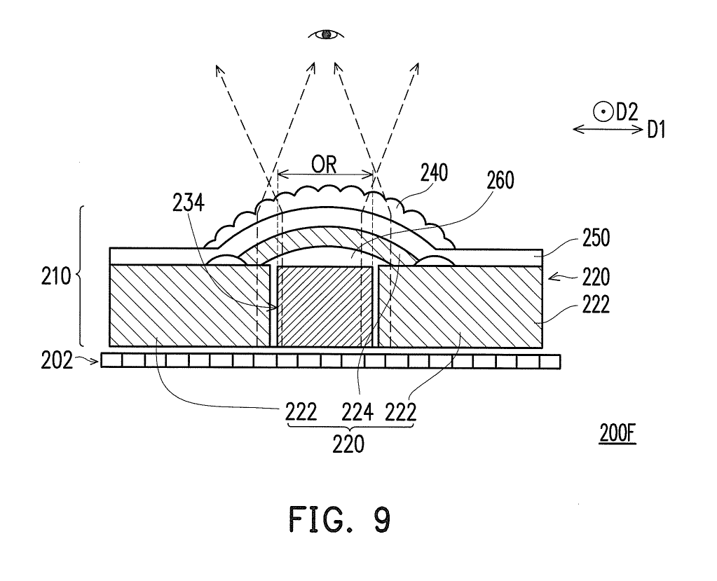

FIG. 9 is a cross-sectional schematic view illustrating an intersection of two touch sensing series of a touch display panel according to a sixth embodiment of the invention. As illustrated in FIG. 9, a touch display panel 200F described in the sixth embodiment is similar to the touch display panel 200D described in the fourth embodiment. Thus, the same components are labeled by the same reference numbers. In the present embodiment, each of the first conduction lines 224 is across the inter-layer dielectric layer 260 and serially connected with two adjacent first touch sensing pads 222. In other words, the touch display panel 200F has the bridge island design.

Certainly, in the touch display panel 200F of the present embodiment, when the image light on the display panel 202 passes through the insulating layer 240 having the bumps BP, the light scattering effect may also be appropriately produced because of the insulating layer 240 that is equipped with the bumps BP and located over the protecting layer 250. Thereby, the bright spots problem at the intersection of the two touch sensing series may be resolved, so as to provide a favorable visual effect.

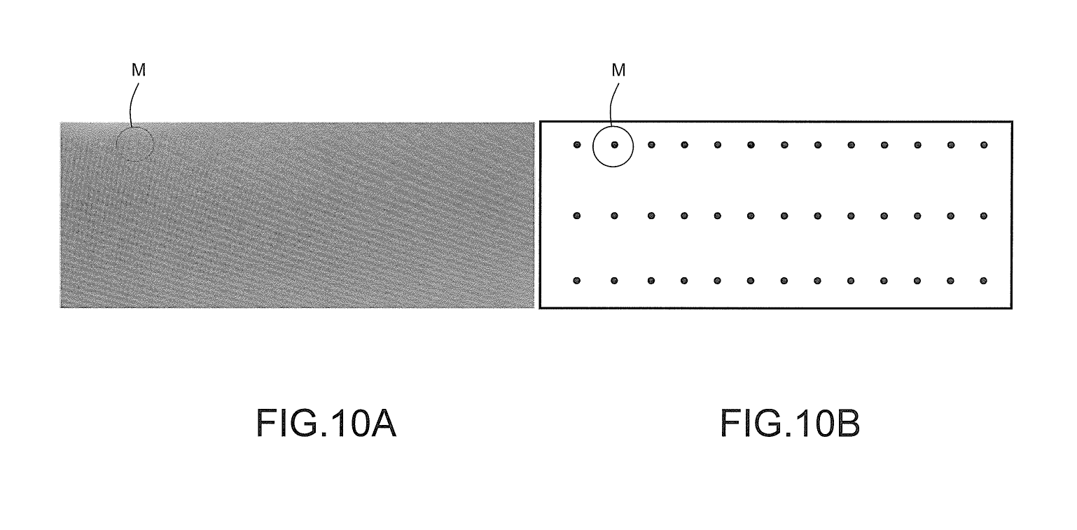

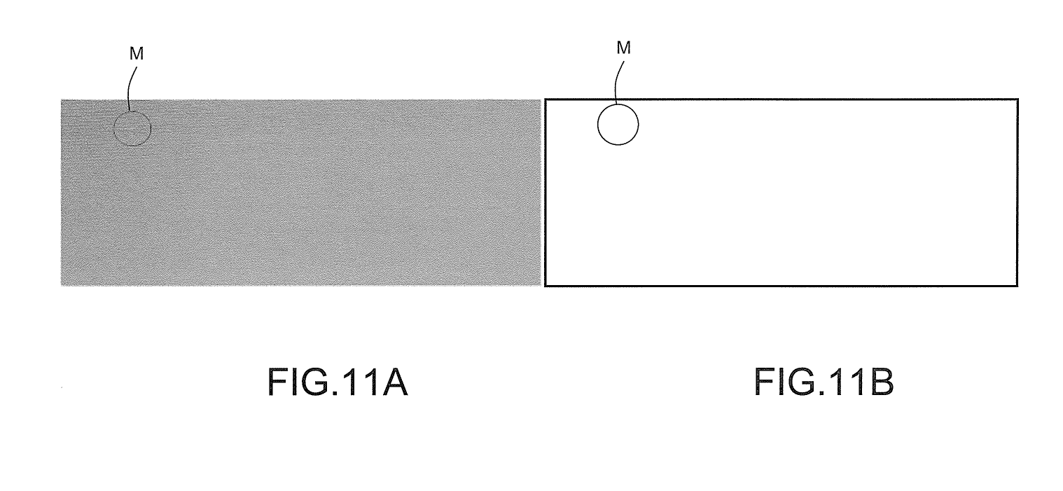

The fact that the touch display panel of the invention can resolve the problem of the bright spots is clearly described below with reference to FIG. 10A to FIG. 10B and FIG. 11A to FIG. 11B.

FIG. 10A is a partially enlarged view illustrating a conventional touch display panel which is not equipped with an insulating layer having a plurality of bumps, and FIG. 10B is a top view showing the touch display panel that is depicted according to the arrangement shown in FIG. 10A. FIG. 11A a partially enlarged view illustrating a conventional touch display panel which is equipped with an insulating layer having a plurality of bumps, and FIG. 11B is a top view showing the touch display panel that is depicted according to the arrangement shown in FIG. 11A.

As shown in FIG. 10A to FIG. 10B and FIG. 11A to FIG. 11B, when a touch display panel is not equipped with an insulating layer having a plurality of bumps, the bright spots are clearly identified in a region M shown in the top view of FIG. 10B, and the after-images are equidistantly arranged along the horizontal direction. A distance between two spots is equal to the distance between two touch sensing series. On the other hand, when an insulating layer having a plurality of bumps is disposed in the touch display panel, as shown in FIG. 11A and FIG. 11B, the regular, clear bright spots in the region M that is at the same position as that illustrated in FIGS. 10A and 10B are scattered and can no longer be identified. Compared with the touch display panel shown in FIG. 10A and FIG. 10B, the touch display panel shown in FIG. 11A and FIG. 11B has superior visual quality according to the present embodiment.

To sum up, in the touch display panel of the invention, the area of the insulating layer projected on the display panel covers the overlapped region at the intersection of each of the first touch sensing series and each of the second touch sensing series, and the bumps are configured on the surface of the insulating layer within the overlapped region of the two touch sensing series, so that the image light on the display panel may be scattered. Thereby, the problems that the pixels are magnified and the internal structures are visually seen are effectively solved, and the bright spots issue at the intersection of two touch sensing series can be resolved as well. Accordingly, the touch display panel of the invention achieves a favorable visual effect.

Although the invention has been described with reference to the above embodiments, it is not limited thereto. It is apparent to one of the ordinary skill in the art that modifications to the described embodiments may be made without departing from the spirit of the invention. Accordingly, the scope of the invention will be defined by the attached claims not by the above detailed descriptions. For example, the shapes of the touch sensing pads may be modified. The touch sensing series may not be orthogonally intersected and may be intersected at other angles. The quantity of the conduction lines between two adjacent touch sensing pads may be one or more. It is intended that the invention cover modifications and variations of this invention provided they fall within the scope of the following claims and their equivalents.

What is claimed is:

1. A touch display panel, comprising:
a display panel, comprising a plurality of pixels; and
a touch panel located on the display panel and comprising a plurality of first touch sensing series, a plurality of second touch sensing series, and an insulating layer, wherein an overlapped region is formed at an intersection of each of the first touch sensing series and each of the second touch sensing series, an area of the insulating layer orthogonally projected on the display panel covers each overlapped region, and a surface of the insulating layer has a plurality of bumps corresponding to each overlapped region.

2. The touch display panel as claimed in claim 1, wherein the insulating layer is located between each of the first touch sensing series and each of the second touch sensing series, each of the first touch sensing series comprises a plurality of first touch sensing pads and a plurality of first conduction lines, each of the first conduction lines is located between two adjacent the first touch sensing pads, each of the second touch sensing series comprises a plurality of second touch sensing pads and a plurality of second conduction lines, and each of the second conduction lines is located between two adjacent second touch sensing pads.

3. The touch display panel as claimed in claim 2, wherein the insulating layer comprises a plurality of dielectric island patterns, and each of the dielectric island patterns is located between one of the first conduction lines and one of the second conduction lines.

4. The touch display panel as claimed in claim 2, wherein the insulating layer comprises a plurality of openings located at two ends of the first conduction lines, and the first touch sensing pads are serially connected with the first conduction lines via the openings.

5. The touch display panel as claimed in claim 1, further comprising:
a protecting layer covering the first touch sensing series and the second touch sensing series, wherein the insulating layer is located on the protecting layer; and
an inter-layer dielectric layer located between each of the first touch sensing series and each of the second touch sensing series, wherein an upper surface of the inter-layer dielectric layer away from the pixels is a convex surface.

6. The touch display panel as claimed in claim 5, wherein the area of the insulating layer projected on the display panel is larger than an area of the inter-layer dielectric layer projected on the display panel.

7. The touch display panel as claimed in claim 5, wherein each of the first touch sensing series comprises a plurality of first touch sensing pads and a plurality of first conduction lines, each of the first conduction lines is located between two adjacent first touch sensing pads, each of the second touch sensing series comprises a plurality of second touch sensing pads and a plurality of second conduction lines, and each of the second conduction lines is located between two adjacent second touch sensing pads.

8. The touch display panel as claimed in claim 7, wherein the inter-layer dielectric layer comprises a plurality of dielectric island patterns, and each of the dielectric island patterns is located between one of the first conduction lines and one of the second conduction lines.

9. The touch display panel as claimed in claim 7, wherein the inter-layer dielectric layer comprises a plurality of openings located on two ends of the first conduction lines, and the first touch sensing pads are serially connected with the first conduction lines via the openings.

10. The touch display panel as claimed in claim 1, wherein a height of each of the bumps is smaller than 20 micrometers.

11. The touch display panel as claimed in claim 1, wherein a distance between each of the bumps is smaller than 15 micrometers.

12. The touch display panel as claimed in claim 1, wherein a dimension of each of the bumps is smaller than 30 micrometers.

13. The touch display panel as claimed in claim 2, wherein the first conduction lines and the second conduction lines are made of transparent conductive material or metal.
